(19) United States
(12) Patent Application Publication
(10) Pub. No.: US 2021/0247972 A1
(43) Pub. Date: Aug. 12, 2021

(54) Social Brokering of Information About Product Changes Pertaining to Commerce Transactions

(71) Applicant: International Business Machines Corporation, Armonk, NY (US)

(72) Inventors: John Handy Bosma, Leander, TX (US); Jana H. Jenkins, Raleigh, NC (US); Rosa M. Bolger, Austin, TX (US); Jeremy R. Fox, Georgetown, TX (US)

(21) Appl. No.: 16/786,341

(22) Filed: Feb. 10, 2020

(51) Int. Cl. G06F 8/65; G06Q 50/00; G06Q 30/02; H04L 29/08

(52) U.S. Cl. CPC G06F 8/65; H04L 67/34; G06Q 30/0282; G06Q 50/01

(57) ABSTRACT

A method, system and computer-usable medium are disclosed for identifying product updates tailored to devices according a selection criteria. The selection criteria is implemented through social brokerage, by receiving feedback from trusted users or influencers. A user provides an indications of products, such as software applications or commerce applications to be monitored for changes. Information as to updates to the products are periodically monitored to provide possible candidate updates. The candidate updates are analyzed based on the selection criteria to form an update assessment, and based on the update assessment an action, such as updating the product is performed.

### BACKGROUND OF THE INVENTION

### Field of the Invention

The present invention relates in general to the field of computers and similar technologies, and in particular to software utilized in this field. Still more particularly, it relates to a method, system and computer-usable medium for improved identification of product and software updates tailored to devices according to a selection criterion.

### Description of the Related Art

Products, and particularly software applications running on devices or information handling systems, can have periodic and numerous updates or upgrade changes. For example, software application updates, can include digital downloads (i.e., delivery) from various sources. A user or customer can be advised of an update to a software application and perform a download of the upgrade.

There can be numerous updates for products and software applications. Out of all the available and numerous updates, users or customers are faced to determine which updates are most important, and which aspects of the updates are most important. Users or customers, especially those of online products and software applications, can inadvertently miss that products or software applications may have changed in key ways, can fail to understand the impact of specific update changes, and can make update decisions without adequate information during the product or software application buying or selection process.

Typically, providers or sellers can notify users or customers of updates by providing a description of changes, sending notifications, or in marketplaces and online application stores, providing a listing of all updates along with filtered reviews for the most recent software versions. There can be several drawbacks to these approaches. Updates about product changes can be easy to miss. Updates may be created in the interests of the seller or provider of the product or software application, rather than the user or customer. For example, a seller or provider may desire to have users or customers update to a 64 bit operating system; however, users or customers that are running software applications that depend on a. 32 bit operation system cannot run their existing 32 bit software applications on a 64 bit operating system.

There can be numerous updates for users or customers to keep up with. Users or customers may have to process a large volume of information as to available updates. This can also obscure or omit the direct experience and feedback of users or customers who have gone through an update or upgrade.

Online application stores and operating systems may provide a summary of available updates, but each update may be treated as the same in importance. This tends to lead to information overload and poor decisions on whether and when to update at a software application, service, or operating system level. Online application stores and operating systems may provide ratings for updates, but such ratings may usually be from other users unknown to the user or customer that is looking to update. Therefore, credibility of the source of the rating can be in question.

Update summary information and ratings may require navigating through a list. Users and customers may be forced to be reliant on summaries of those offering the update, and on ratings and commentary which may not be credible. Typically, users and customers are not in a position to request feedback from opinion leaders in an automated fashion, and can lead to inefficiencies in getting expert opinion and recommendations as to an update, what to consider in making a decision as to an update, and what to do to prepare for an update.

### SUMMARY OF THE INVENTION

A method, system and computer-usable medium are disclosed for identifying product updates tailored to devices according a selection criteria. The selection criteria is implemented through social brokerage, by receiving feedback from trusted users or influencers. A user provides an indication of products, such as software applications or commerce applications to be monitored for changes. Information as to updates to the products are periodically monitored to provide possible candidate updates. The candidate updates are analyzed based on the selection criteria to form an update assessment, and based on the update assessment an action, such as updating the product is performed.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a general illustration of components of a service server as implemented in the system and method of the present invention;

FIG. 2 is a general illustration of components of user device as implemented in the system and method of the present invention;

FIG. 3 is general illustration of a system of social brokering of information about product changes pertaining to commerce transactions;

FIG. 4 is a listing of data included in a data structure accessible by a service server; and

FIG. 5 is a generalized flowchart of the operation of identification of product and software updates tailored to devices according to a selection criterion.

### DETAILED DESCRIPTION

A system, method, and computer-readable medium are disclosed for improved identification of product and software updates tailored to devices according to a selection criterion. Users are provided an automated means for soliciting expert or trusted recommendations as to updates, and information regarding such updates, through collaborative and collective knowledge.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

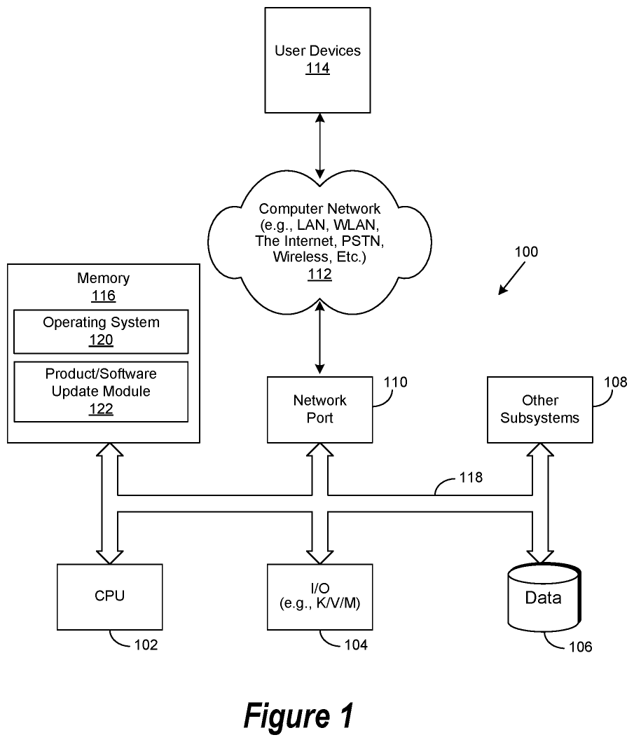

FIG. 1 is a generalized illustration of an information handling system 100 that can be used to implement the system and method of the present invention. In certain implementations, the information handling system 100 is a service server that identifies product and software updates tailored to devices according to a selection criterion. The information handling system or service server 100 can be configured to receive an indication of products or software applications to monitor for changes from a user, monitor information periodically about the indicated products or software to determine updates to the products or software to form candidate updates, analyze the candidate updates against the selection criteria to form an update assessment, and perform an action based on the update assessment.

The information handling system or service server 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage or data store 106, and various other subsystems 108. Specific information that is stored in data store 106 is further described below. In various embodiments, the service server 100 also includes network port 110 operable to connect to a network 112, which is likewise accessible by user devices 114. The network 112 may include local network connections and remote connections in various embodiments, such that information handling system 100 may operate in environments of any size, including local and global, e.g., the Internet. The network 112 may be a public network, such as the Internet, a physical private network, a wireless network, a virtual private network (VPN), or any combination thereof. Skilled practitioners of the art will recognize that many such embodiments are possible, and the foregoing is not intended to limit the spirit, scope or intent of the invention.

The service server 100 likewise includes system memory 116, which is interconnected to the foregoing via one or more buses 118. System memory 116 further comprises operating system (OS) 120. In certain embodiments, the system memory 116 includes a product software update module 122, that implements the methods as described herein.

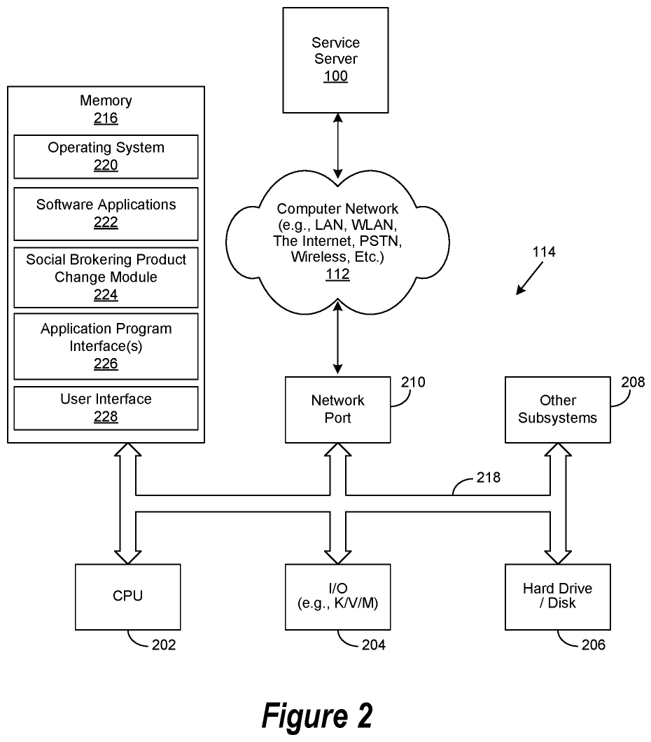

FIG. 2 is a generalized illustration of an information handling system or user device 114 that that can be used to implement the system and method of the present invention. In certain implementations, the user device 114 interacts with the service server 100 and other entities as further described below.

The user device 114 includes a processor (e.g., central processor unit or “CPU”) 202, input/output (I/O) devices 204, such as a microphone, a keyboard, a video/display, a mouse, and associated controllers (e.g., K/V/M), a hard drive or disk storage 206, and various other subsystems 208. In various embodiments, the information handling system or user device 114 also includes network port 210 operable to connect to the network 112, which is likewise accessible by service server 100.

The user device 114 likewise includes system memory 216, which is interconnected to the foregoing via one or more buses 218. System memory 216 further comprises operating system (OS) 220. The system memory 216 includes software applications 222. Operating system 220 and software applications 222 can be updated or upgraded periodically or from time to time, when such updates or upgrades are made available. Furthermore, in certain implementations, components of the user device 114 can also be updated or upgraded.

In certain implementations, the system memory 216 includes application program interface(s) (API) 226 and a user interface 228 used to interact with the service server 100, and other entities connected to network 112, as further described below. An API can be an interface or communication protocol between the user device 114 and other entities, including the service server 100. As discussed further below, APIs 226 can be used to access social media networks, software suppliers/providers, online application stores, online marketplaces, etc.

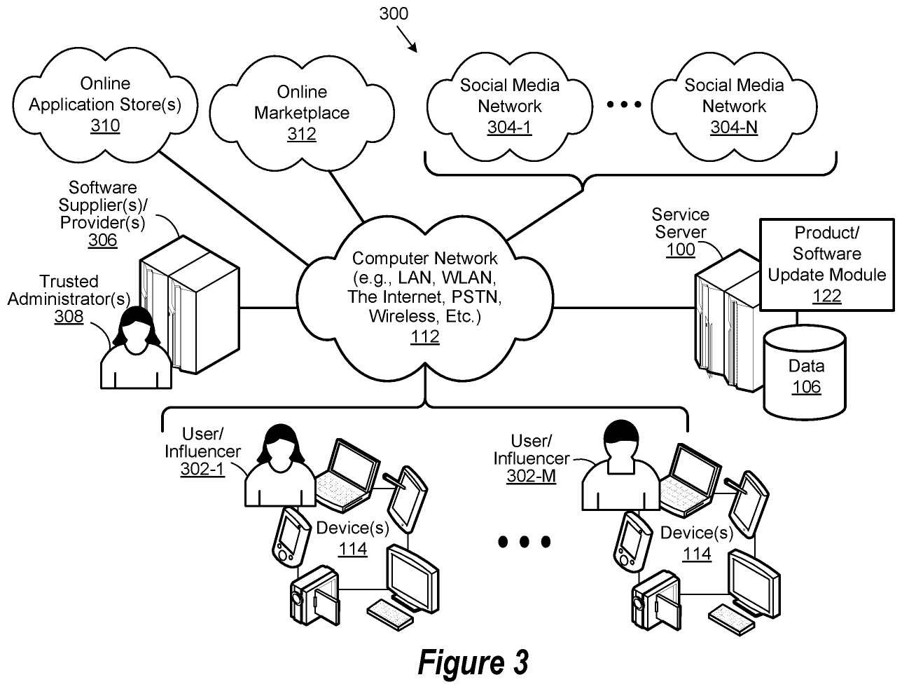

FIG. 3 is a simplified block diagram of a system of social brokering of information about product changes pertaining to commerce transactions. The system 300 in particular supports commerce transactions of products and software applications. The system 300 includes the service server 100 and user devices 114. In particular, users/influencers 302-1 to 302-M perform operations through user devices 114. As discussed, user devices 114 refer to an information handling system. User devices 114 can include a personal computer, a laptop computer, a tablet computer, a personal digital assistant (PDA), a smart phone, a mobile telephone, or other device that is capable of communicating and processing data. Users/influencers 302 can include users that provide feedback, including ranking and commentary, regarding particular updates that can be performed or provided to user devices 114. In this regard, social brokering of information regarding product or software changes is supported.

In certain implementations, the described actions are implemented by the product/software update module 122 accessing the data store 106, and through associated APIs and user interfaces at particular control points of the various entities as described.

In certain instances, a user/influencer 302 implements the use of a product or software application on their user device 114. In other instances, a user/influencer 302 may be a trusted or respected influencer that does not necessarily implement or use the product or software application but has knowledge of product or software application and updates or upgrades.

The user devices 114 are connected to the network 112, and through the network 112, are connected to service server 100. It is to be understood, that in certain implementations the service server 100 can include multiple servers/computing devices, which can also include cloud computing services. The service provided by service server 100 through the product/software update module 122, enables users/influencers 302 to track updates to products, operating systems, software applications, when such are installed on respective user devices 114 controlled by a user/influencer 302.

Users/influencers 302 can register with the service server 100 to receive information about updates or upgrades applicable to the specific user devices 114 that they control. In certain implementations, users can identify a group or network of other users/influencers 302 that are trusted who are also registered with service server 100. Users/influencers 302 can be notified by the service server 100, and particularly through the product/software update module 122, as to available updates, can be given the opportunity to provide feedback if an update is performed, and/or can retrieve overall feedback or feedback of other trusted users/influencers 302 in order to initiate a product or software application update. Therefore, instead of relying on online summaries and ratings of updates and searching and browsing for information about updates, users/influencers 302 can be notified of when updates are offered and provided relevant and specific update information and summaries.

The system 300 includes various social media network 304-1 to social media network 304-N. Examples of social media networks include Facebook®, Gmail®, Instagram®, etc. The social media networks 304 can include pre-existing interfaces (e.g., API) accessible by service server 100. In particular, users/influencers 302 are connected with one or more of the social media networks 304. Users/influencers 302 can log onto their user accounts of the social media networks 304, and provide feedback, commentary, ranking, etc. related to particular updates specific to products and software applications. In certain implementations, users/influencers 302 that register with the service server 100 provide their network information to service server 100 to be able to retrieve relevant data/information provided by users/influencers 302 related to updates.

In certain implementations, the product/software update module 122 manages such network information. Through integration of social media networks 304 with the users/influencers 302 and providing the necessarily interfaces, users/influencers 302 can establish a group or network of trusted users/influencer(s) 302. Users/influencers 302 can identify trusted users/influencer(s) 302 in their trusted group or network, whose feedback on updates they desire to track.

The system 300 further can include software supplier(s)/provider(s) 306, trusted administrator(s) 308, online application store(s) 310, and online marketplace 312. In certain implementations, the product/software update module 122 can offer and provide an API for software supplier(s)/provider(s) 306 and trusted administrator(s) 308 to identify specific updates to products or software applications, where products can be commerce applications. The product/software update module 122 can link such updates to online application store(s) 310 and online marketplace 312, when the updates are available.

In certain implementations, when a product or software application is registered on a user device 114, the product/software update module 122 iterates through the product or software application on the user device 114. Users/influencers 302 can opt in, such that all products or software applications installed on user device 114 are tracked or can choose from a list of products or software applications to track updates for.

In certain implementations, when the product/software update module 122 detects that an update is available, a unique record for that update is made available. The update can be made available as online content and provided through an API, such as from software supplier(s)/provider(s) 306, online application store(s) 310, online marketplace 312, etc. In certain implementations, the product/software update module 122 provides updates for particular products or software applications on specific devices 114 and specific operating systems running on devices 114 (e.g.; iOS® vs. Android® software application).

In certain implementations, the product/software update module 122 provides for users/influencers 302 to follow a specific update, or to upgrade. Certain implementations allow for users/influencers 302 with certain privileges or have a specific trust level to follow specific updates or upgrades. Information related to such specific updates or upgrades can be tracked and pulled from online application store(s) 310 and online marketplace 312 by the product/software update module 122, such as through an API.

In certain implementations, the product/software update module 122 tracks which users/influencers 302 have performed updates and can prompt such users/influencers 302 for feedback as to the update(s). Certain implementations can also provide for the product/software update module 122 to track specific system or user device 114 events such as failed installations if available.

“Clip levels” can be calculated or set, where a “clip level” can be defined as a certain minimum number of users/influencers 302 ratings as to a particular update, which can be adjusted as to a rating level (e.g., 4 out of 5 recommendation level). In certain implementations, a user/influencer 302 may set a “clip level” as to an update, where if the “clip level” is reached, the update is performed automatically. Therefore, ratings are calculated, and if the “clip level” is reached, the user/influencer 302 is notified, the updated is performed per the user/influencer 302 chosen options. In certain implementations, a user/influencer 302 may rely on other trusted users/influencers 302 as to recommendation for an upgrade. The recommendation from trusted users/influencers 302 can override a “clip level” determination. In other words, the user/influencer 302 may perform the update, when trusted users/influencers 302 set a flag or provide an indication that the update is important/needed, overriding the “clip level” or other update determinative factors.

In certain implementations, the product/software update module 122 receives commentary regarding updates from users/influencers 302. An API can be invoked for sentiment analysis and can be used to provide information to end users/influencers 302. In certain implementations, sentiment analysis can be used for the “clip level” automated updates as described above.

In certain implementations, automated billing can be performed by the product/software update module 122 when updates are performed. The automatic billing can be an option to users/influencers 302, based on certain factors, such as when a “clip level” is reached, when trusted users/influencers 302 in a trusted group or network recommend the update, etc. A message can be sent to the user/influencer 302 when billing is performed.

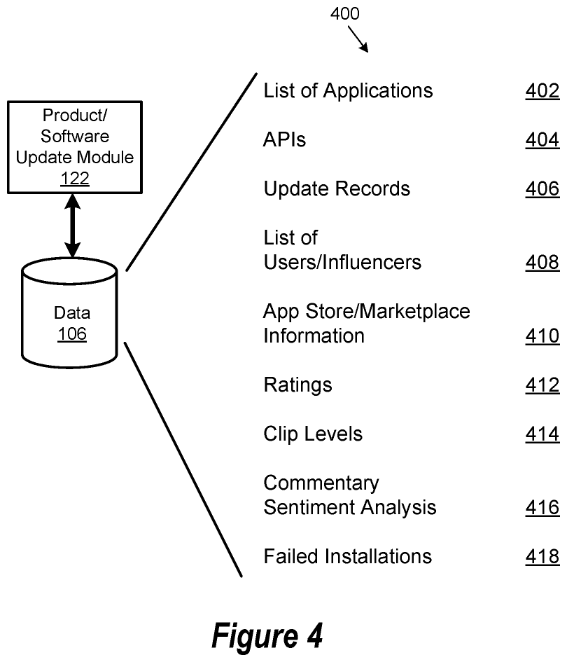

FIG. 4 shows a listing of information or data included in a data structure accessible by a service server. As discussed, in certain implementations, the product/software update module 122 product/software update module 122 access the data store 106, and through associated APIs and user interfaces at particular control points of the various entities as described.

The data store 106 can store various data and information as represented by list 400. For example, a list of products, software applications (e.g., commerce applications) 402 can be stored by data store 106. In particular, such products and software applications are provided updates. Users/influencers 302 can choose from the list of applications 402 as to which applications to track for updates. Data store 106 can include various APIs as discussed above, including APIs to access updates and content. The data store 106 can include update records 406 as to products and software applications. The update records 406 can include update versions. Data store 106 can include a list of users/influencers 302. The data store 106 can include information 410 as to online application store(s) 310 and online marketplace 312. Other data/information stored in data store 106 can include ratings of updates 412, where each rating can be related to particular update versions. Data store 106 can further store “clip levels” 414 as discussed above. Commentary and sentiment analysis 416 can also be stored. In certain implementations, the data store 106 can store a record of failed update installations 418.

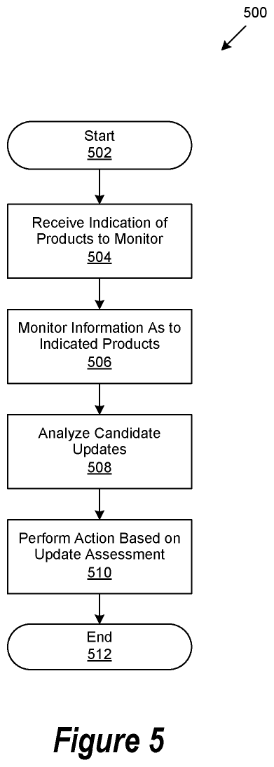

FIG. 5 is a generalized flowchart 500 for identification of product and software application updates tailored to devices according to a selection criteria. The selection criteria can be based on a social brokerage that implements feedback from a trusted group or network of common users or influencers that have knowledge of the product or software application and updates or upgrades affecting product or software application.

The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 502, the process 500 starts. At step 504, an indication is received as to products, such as software applications, commerce applications to monitor. Users, such as users/influencers 302 can provide the indication as to products that they desire to be monitored, and particularly for updates or upgrades.

At step 506, monitoring information is performed, which can be periodically about the indicated products, and particular as to updates which can be provided as candidate updates for the products.

At step 508, the candidate updates are analyzed against the selection criteria to form an update assessment. The selection criteria can be based on feedback from users or influencers that are different than the user requesting products to be monitored. The update assessment can be in the form of summaries, rankings, recommendations (e.g., commentary) as described above.

At step 510, an action is performed based on the update assessment. The action can include performing the update, or not performing the update. In certain implementations, the action that is performed is automatically installing an update based on rating from a user or influencer that is different than the user requesting products to be monitored. At block 518, the process 500 ends.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method for identifying product updates tailored to devices according to a selection criteria comprising:
receiving an indication of products to monitor for changes from a user;
monitoring information periodically about the indicated products to determine updates to the products to form candidate updates;
analyzing the candidate updates against the selection criteria to form an update assessment, wherein the selection criteria is based on a feedback from different users meeting a trust criteria and performing the updates, wherein a clip level is set as to a minimum number of user ratings, the clip level set by the user;
overriding the clip level as to when a recommendation is made by a trusted user; and
performing an action based on the update assessment.

2. The computer implemented method of claim 1, wherein the product updates are for commerce or software applications.

3. (canceled)

4. The computer implemented method of claim 1, wherein the action is automatically installing the update based on a rating from the different users.

5. The computer implemented method of claim 1, wherein the updates have different versions.

6. The computer implemented method of claim 1, wherein the selection criteria is based on social brokering from one or more social media networks.

7. The computer implemented method of claim 1, wherein the performing the action is automatically based on user defined factors that set the clip level.

8. A system comprising:
a processor;
a data bus coupled to the processor; and
a computer-usable medium embodying computer program code, the computer-usable medium being coupled to the data bus, the computer program code used for identifying product updates tailored to devices according to a selection criteria comprising instructions executable by the processor and configured for:
receiving an indication of products to monitor for changes from a user;
monitoring information periodically about the indicated products to determine updates to the products to form candidate updates;
analyzing the candidate updates against the selection criteria to form an update assessment, wherein the selection criteria is based on a feedback from different users meeting a trust criteria and performing the updates, wherein a clip level is set as to a minimum number of user ratings, the clip level set by the user;
overriding the clip level as to when a recommendation is made by a trusted user; and
performing an action based on the update assessment.

9. The system of claim 8, wherein the product updates are for commerce or software applications.

10. (canceled)

11. The system of claim 8, wherein the action is automatically installing the update based on a rating from the different users.

12. The system of claim 8, wherein the updates have different versions.

13. The system of claim 8, wherein the selection criteria is based on social brokering from one or more social media networks.

14. The system of claim 8, wherein the performing the action is automatic based on user defined factors.

15. A non-transitory, computer-readable storage medium embodying computer program code, the computer program code comprising computer executable instructions configured for:
receiving an indication of products to monitor for changes from a user;
monitoring information periodically about the indicated products to determine updates to the products to form candidate updates;
analyzing the candidate updates against the selection criteria to form an update assessment, wherein the selection criteria is based on a feedback from different users meeting a trust criteria and performing the updates, wherein a clip level is set as to a minimum number of user ratings, the clip level set by the user;
overriding the clip level as to when a recommendation is made by a trusted user; and
performing an action based on the update assessment.

16. The non-transitory, computer-readable storage medium of claim 15, wherein the product updates are for commerce applications.

17. The non-transitory, computer-readable storage medium of claim 15, wherein the performing the action is automatic based on user defined factors.

18. The non-transitory, computer-readable storage medium of 17, wherein the action is automatically installing the update based on a rating from the different users.

19. The non-transitory, computer-readable storage medium of 15, wherein the updates have different versions.

20. The non-transitory, computer-readable storage medium of 15, wherein the selection criteria is based on social brokering from one or more social media networks.

21. The computer implemented method of claim 1, wherein sentiment analysis is provided for automated clip level updates.

22. The system of claim 8, wherein sentiment analysis is provided for automated clip level updates.
